(19) United States
(12) Patent Application Publication
(10) Pub. No.: US 2011/0217652 A1
(43) Pub. Date: Sep. 8, 2011

(54) PROCESS FOR APPLYING A POWDER COATING

(75) Inventor: Kevin Jeffrey Kittle, Durham (GB)

(73) Assignee: Akzo Nobel Coatings International B.V., Arnhem (NL)

(21) Appl. No.: 13/125,596

(22) PCT Filed: Oct. 20, 2009
(86) PCT No.: PCT/EP09/63697

§ 371 Date: Apr. 22, 2011

Related U.S. Application Data
(60) Provisional application No. 61/111,138, filed on Nov. 4, 2008.

(30) Foreign Application Priority Data
Oct. 23, 2008 (EP) 08167388.1

(51) Int. Cl. G03G 13/08; B44C 1/17

(52) U.S. Cl. 430/120.1; 156/230; 156/235

(57) ABSTRACT

A process for coating a substrate comprising the sequential steps of (i) providing a transfer sheet provided with clear coat layer and a printed powder coating, toner, or UV-curable ink on top of that, (ii) applying the transfer sheet onto the substrate with the coating in contact with the substrate, and (iii) curing the coating on the substrate.

The present invention pertains to a process for applying a powder coating onto a substrate.

Conventionally, powder coatings are applied onto substrates using spray guns or fluidised beds. Both these processes have the disadvantage that they can only deposit powder coatings in a single colour on the entire substrate. Any lettering or other decoration will have to be applied in a separate process step.

U.S. Pat. No. 5,955,152 provides an alternative method for applying a powder coating onto a substrate. This reference describes a method wherein a powder coating is applied onto a substrate via an electrostatic printing process comprising forming an electrostatic latent image on a light-sensitive body, developing the electrostatic latent image by making a thermosetting powder coating material adhere under electrostatic force to the light-sensitive body, transferring the powder coating material on the light-sensitive body onto the substrate to be coated, and curing the powder coating in such a way that it adheres to the substrate. The reference also describes a method wherein the powder coating material on the light-sensitive body is transferred onto a transfer sheet, and the powder coating material is cured as it is pressed against the substrate to be coated, thereby baking the powder coating material onto the substrate; followed by peeling the transfer sheet from the cured coating layer.

While the transfer sheet process described in U.S. Pat. No. 5,955,152 makes it possible to deposit powder coatings with different colours onto a single substrate in a single step, it appears that it still has some disadvantages.

In the first place, it appears that when the transfer sheet is used to apply a decoration on part of a coated substrate, e.g., a logo onto an already coated refrigerator door, the decoration can easily be scratched off or worn out.

Second, the powder coating has a tendency to shrink during cure, which has a negative effect on the appearance of the decoration.

Third, the printed image, especially when applied to a substrate covered with a (partly cured) base coat, will have the tendency to move during cure. And further, spots of powder coating may remain on the transfer sheet, which ruins the whole image.

A way to solve some of the above problems is to apply a clear coat on top of the cured printed image. However, simply applying a clear coat on top of said printed image would take two application steps and two curing steps. This is not only time consuming, it also requires an additional heating cycle which may be detrimental to heat-sensitive substrates (e.g. plastics). This process further does not solve the problem of movement of the printed image during cure and powder coating spots remaining on the transfer sheet.

These above problems are solved by the process of the present invention. The present invention provides a process for coating a substrate comprising the sequential steps of providing a transfer sheet provided with a clear coat layer and a printed powder coating on top of said clear coat layer, applying the transfer sheet onto the substrate with the coating in contact with the substrate, and curing the coating on the substrate.

So, the transfer sheet is pre-coated with a clear coat composition prior to its provision with the printed powder coating. The advantage of having this clear coat composition pre-coated on the transfer sheet is that the clear coat composition will be co-applied with the powder coating onto the substrate, resulting in a clear coat on top of the powder coating, which inhibits shrink of the powder coating during cure and makes the powder coating decoration less easy to be scratched off.

Further, with this process a protective coating layer is applied and not only an image layer. And only one curing step is required for both the printed image and the clear coat, which is time-effective and makes the process suitable for coating heat-sensitive substrates such as plastics.

Additional advantages of the process of the present invention are that movement of the printed image during cure is significantly reduced and that no printed powder coating spots which make up the image will remain on the transfer sheet.

The clear coat may be completely clear, but may also have some tinting, matting, sparkling or metallic effect. However, it should be sufficiently clear to be able to see the underlying powder coating image on the substrate.

The clear coat composition can be a powder or a liquid coating composition and can be applied by any suitable method. For instance, it can be applied to the transfer sheet by printing, electrostatic spray-coating, casting as a melt If the clear coat is a liquid coating, it can be applied by printing, roll-coating, spray-coating, or drawing down with an applicator bar.

It has also been found that the same process is suitable for applying toners and UV curable-inks to a substrate. In this specification, toners are defined as being absent of curing agent, whereas powder coatings do contain a curing agent.

Hence, the application also relates to a process for coating a substrate comprising the sequential steps of providing a transfer sheet provided with a clear coat layer and a printed toner on top of said clear coat layer, applying the transfer sheet onto the substrate with the coating in contact with the substrate, and curing the coating on the substrate.

And the application further relates to a process for coating a substrate comprising the sequential steps of providing a transfer sheet provided with a clear coat layer and a printed UV-curable ink on top of said clear coat layer, applying the transfer sheet onto the substrate with the coating in contact with the substrate, and curing the coating on the substrate.

The clear coat on the transfer sheet can be submitted to a temporary fixing step in which it is heated to a temperature below its curing temperature in such a way that it is temporarily fixed on the transfer sheet. Alternatively, the clear coat on the transfer sheet is fully cured prior to the application of the powder coating. This curing can be performed by any method, including heat, air, or UV.

It is also possible to use a non-curable clear coat.

The choice of clear coat depends on the nature of the transfer sheet and the compatibility with the powder coating, toner, or ink. However, if a toner is used, the clear coat must be curable and should be cured either before or after application to the substrate.

Preferably, the transfer sheet is removed from the coating before the coating is cured. This leads to a number of advantages.

In the first place, it was found that when the coating is cured only after the transfer sheet is removed, the surface properties of the cured coating will mach those of any underlying coating layer. This means that even when only part of a substrate is provided with a coating via a transfer sheet, the coating will have a surface appearance matching the underlying paint finish. Further, also when the entire surface of a substrate is provided with a decoration via the method according to the invention, the resulting decoration has more depth and character of image as compared to the relatively flat results obtained via the method described in U.S. Pat. No. 5,955,152.

In the method of this invention it is also easy to apply coatings layers or decorations adjoining each other. This can be done by repeating the deposition part of the process, comprising the steps of applying the coated transfer sheet onto the substrate with the coating in contact with the substrate and removing the transfer sheet as many times as desired, and then subjecting the entire decorated substrate to a curing step. As each transfer sheet is applied after the previous transfer sheet has been removed, matching the patterns of the adjoining sheets is not hard. As all decorations will be cured simultaneously, the effects associated with different curing conditions will not occur.

Further, if the coating layer is damaged during removal of the transfer sheet, the fact that the coating is at that point in time not cured may make for easier removal of the coating, so that the substrate can be cleaned and the transfer sheet re-applied.

Additionally, the material of which the transfer sheet is made can be optimised for printing and transfer properties, without having to withstand the conditions prevailing during curing, making a wider selection of materials available for use in the process.

The process according to the invention allows the application of any design in one or more colours onto a substrate in a single step.

Further advantages associated with the process of the present invention will become apparent from the document below.

In the first step of the process according to the invention, a transfer sheet is provided with a clear coat layer and a printed powder coating, toner, or ink on top of that. The printing process can be any conventional printing process via which powder materials, toners, or ink are applied onto a substrate. Suitable printing processes include those comprising the following steps. In a first step an electrostatic latent image is formed on a light-sensitive body. In a second step the electrostatic latent image is developed by letting the powder coating, toner, or ink adhere under electrostatic force to the light-sensitive body. Then, the powder coating, toner, or ink on the light-sensitive body is transferred onto the clear coated layer on the transfer sheet. For more details on suitable printing processes reference is made to U.S. Pat. No. 5,955,152.

In one embodiment a plurality of powder coatings, toners, or inks of different colours are sequentially printed onto the clear coat layer on the transfer sheet, for example by means of the latent-image forming step, developing step and transfer step. Then the plurality of powder coatings/toners/inks together with the clear coat are transferred onto the substrate. This provides an easy method of providing a substrate coated with a design containing multiple colours. It should also be noted that the use of a transfer sheet makes for a more risk-free coating process than direct printed onto the substrate, in that a miss-print on a transfer sheet is less expensive than a miss-print on a final substrate.

The plurality of types of powder coatings, toners, and inks include powder coatings, toners, and inks of the standard printing colours cyan, yellow, magenta, and black. This will allow the provision of any desired colour.

In one embodiment the substrate is provided with a coating before it is subjected to the process according to the invention. This coating can be applied via conventional methods. This base coat may have any colour, including white, or may be clear. The thickness of this base coat layer is preferably about 1-200 microns, more preferably 10-150 microns. The base coat layer being a powder coating layer may be particularly preferred.

The base coat may have been fully cured prior to the application of the transfer sheet onto the substrate. Preferably, however, this base coat layer has not been fully cured at that stage. Curing the base coat at a later stage, e.g. together with the powder coating, will prevent shrinkage of the powder coated image.

Using a base coat further reduces movement of the image during cure.

Alternatively, a base coat is applied to the substrate by way of the transfer sheet. This can be done by applying a base coat layer on top of the printed powder coating, toner, or ink on the transfer sheet. The base coat, together with the printed powder coating, toner, or ink and the clear coat layer are then applied to the substrate with the base coat in contact with the substrate. This base coat can act as a glue or adhesion layer. It additionally makes the coating thicker and of more substance, which helps to reduce shrinkage of powder coatings during cure.

It is further possible to apply a further clear coat layer on top of the base coat layer. This clear coat layer may act as a further glue or adhesion layer.

In one embodiment of the present invention the powder coating, toner, or ink on the transfer sheet is submitted to a temporary fixing step. A powder coating is temporary fixed by heating to a temperature below its curing temperature. The powder coating is heated sufficiently to induce some flow between the powder coating particles, but insufficiently to cause any substantial curing of the powder coating. If so desired, the powder coating is pressed to the transfer sheet during the temporary fixing step, e.g., by using rollers.

A toner or an ink can be temporary fixed using a heated roller or a non-contact heater such as an oven or an infra-red grill.

In an alternative embodiment, the transfer sheet is provided with a clear powder coating layer and a non-curable image. To ensure proper adhesion between the clear coat and the substrate, the surface area of the non-curable image should be less than 75% of the surface area of the clear powder coating layer on the transfer sheet, preferably less than 50%, more preferably less than 25%.

In one embodiment, a protective sheet may be applied onto the coating layer to protect the layer against being damaged before it is applied onto the substrate. Any suitable material can be used for the protective sheet, as long as it can be removed from the coating layer without damaging it. Suitable materials will be evident to the skilled person and include conventional release paper such as waxed paper of grease-proof paper.

The next step in the process according to the invention is applying the transfer sheet on the substrate with the powder coating, toner, or ink or—in case a base coat is applied on top of the powder coating—the base coat in contact with the substrate. The transfer sheet may be applied to a flat surface, but may also be folded around a three-dimentional structure.

How this process step should be carried out will be evident to the skilled person. It may be appropriate to press the transfer sheet against the substrate using rollers or other pressure-generating apparatus. It is also possible, as is known in the art, to cover the substrate with the transfer sheet and then apply a vacuum to press the transfer sheet to the substrate.

In case of powder coatings, is necessary for the powder coating to be heated above its melt temperature while in contact with the substrate if one wants to increase the adherence of the powder coating to the substrate. In general, the conditions during this transfer step should be chosen such that no substantial curing of the coating is observed. In general this means that this process should be done quite rapid and the temperature should not be chosen too high. In general, the powder coating is heated to a temperature of at least 2° C. above the melt temperature, preferably at least 5° C., more preferably at least 10° C. In general, a higher temperature is preferred as this will increase the adherence of the powder coating to the substrate.

If desired, the transfer sheet may then be removed from the coating. The powder coating, toner, or ink layer and the clear coat layer on top of that will be retained on the substrate.

The coating is then subjected to a curing step in which the coating is cured to provide internal integrity and adhesion to the substrate. Preferably, heat curing is used. Curing powder coatings and clear coats is standard technology and requires no further elucidation. In case of inks, UV curing is used.

After cure, the transfer sheet can be removed, if it was not already removed before cure.

In a further embodiment, multiple powder coating, toner, and/or ink layers are applied using a transfer sheet, before the curing step. In such process sequential layers of powder coating, toner, and/or ink are applied using a transfer sheet before the final curing step. This embodiment enables the preparation of a powder coating, toner, and/or ink layer on a substrate with various textures and/or the building of a 3-dimensional structure in the coating layer on the substrate.

This embodiment can be characterised as a process having the sequential steps of
a. providing a transfer sheet provided with a printed powder coating, toner, or UV-curable ink,
b. applying the transfer sheet onto the substrate,
c. removing the transfer sheet from the coating,
d. optionally applying another transfer sheet provided with a printed powder coating, toner, or UV-curable ink onto the previously coated substrate with the powder coating, toner, or UV-curable ink in contact with the previously coated substrate, followed by removal of the transfer sheet from the powder coating, toner, or UV-curable ink,
e. optionally repeating step d) one or more times,
f. applying a final transfer sheet provided with a clear coat layer and a printed powder coating, toner, or UV-curable ink on top of that onto the previously coated substrate with the powder coating toner, or UV-curable ink in contact with the previously coated substrate,
g. optionally removing the transfer sheet from the coating, and
h. curing the coating on the substrate.

The transfer sheet in steps a) and d) may have been provided with a clear coat layer prior the provision of the printed powder coating toner, or UV-curable ink, but this is not essential.

The powder coating used in the process according to the invention is a thermosetting powder coating composition which comprises a resin and a curing agent therefore. The toners used do not contain a curing agent. The powder coating and the toner may further comprise one or more of the conventional additives like pigments, fillers, and opacifyers.

The substrate used in the process according to the invention can be any metal or non-metal substrate in any form or shape. The substrate can be heat-sensitive or able to withstand heating at elevated temperatures.

Examples of substrates that can be used in the process according to the invention include (preformed) metal sheets, medium density fibre-board (MDF), wood, wood products, plastics materials, such as polyamide and polycarbonate. The substrate can be coated or uncoated.

The present invention is not limited to the embodiments discussed above. For example, there is no limitation on the colours of the powder coatings, toners, or inks.

1. A process for coating a substrate comprising the sequential steps of
providing a transfer sheet provided with a clear coat layer and a printed powder coating on top of the clear coat layer,
applying the transfer sheet onto the substrate with the printed powder coating in contact with the substrate, and
curing the printed powder coating on the substrate.

2. A process for coating a substrate comprising the sequential steps of
providing a transfer sheet provided with a clear coat layer and a printed toner on top of the clear coat layer,
applying the transfer sheet onto the substrate with the printed toner in contact with the substrate, and
curing the printed toner on the substrate.

3. A process for coating a substrate comprising the sequential steps of
providing a transfer sheet provided with a clear coat layer and a printed UV-curable ink on top of the clear coat layer,
applying the transfer sheet onto the substrate with the printed UV-curable ink in contact with the substrate, and
curing the printed UV-curable ink on the substrate.

4. The process of claim 1, wherein the transfer sheet is provided by a process, comprising the steps of forming an electrostatic latent image on a light-sensitive body, developing the electrostatic latent image by making the printed powder coating adhere to the light-sensitive body, and transferring the printed powder coating, toner, or ink on the light-sensitive body onto the transfer sheet provided with the clear coat layer.

5. The process of claim 1 wherein a plurality of powder coatings of different colors are sequentially printed onto the transfer sheet provided with the clear coat layer.

6. The process of claim 5 wherein the plurality of of powder coatings include powder coatings of the standard printing colors cyan, yellow, magenta, and black.

7. The process of claim 1 wherein the transfer sheet is folded around a three-dimensional structure.

8. The process of claim 1 wherein the powder coating is temporarily fixed to the transfer sheet by way of a temporary fixing step in which the powder coating is heated to a temperature below its curing temperature.

9. The process of claim 1 wherein the substrate to be coated has a coating layer with a thickness of 1-200 microns.

10. A process for coating a substrate comprising the sequential steps of
a) providing a first transfer sheet provided with a first printed powder coating, toner, or UV-curable ink,
b) applying the first transfer sheet onto the substrate,
c) removing the first transfer sheet from the first printed powder coating, toner, or UV-curable ink,
d) optionally applying a second transfer sheet provided with a second printed powder coating, toner, or UV-curable ink onto the previously coated substrate with the second printed powder coating, toner, or UV-curable ink in contact with the previously coated substrate, followed by removal of the second transfer sheet from the second printed powder coating, toner, or UV-curable ink,
e) optionally repeating step d) one or more times,
f) applying a final transfer sheet provided with a clear coat layer and a final printed powder coating, toner, or UV-curable ink on top of the clear coat layer that onto the previously coated substrate with the final printed powder coating, toner, or UV-curable ink in contact with the previously coated substrate,
g) optionally removing the final transfer sheet from the coating, and
h) curing the coating on the substrate.

11. The process of claim 2, wherein the transfer sheet is provided by a process comprising the steps of forming an electrostatic latent image on a light-sensitive body, developing the electrostatic latent image by making the printed toner adhere to the light-sensitive body, and transferring the printed toner on the light-sensitive body onto the transfer sheet provided with the clear coat layer.

12. The process of claim 3, wherein the transfer sheet is provided by a process comprising the steps of forming an electrostatic latent image on a light-sensitive body, developing the electrostatic latent image by making the printed UV-curable ink adhere to the light-sensitive body, and transferring the printed UV-curable ink on the light-sensitive body onto the transfer sheet provided with the clear coat layer.

13. The process of claim 2 wherein a plurality of printed toners of different colors are sequentially printed onto the transfer sheet provided with the clear coat layer.

14. The process of claim 3 wherein a plurality of printed UV-curable inks of different colors are sequentially printed onto the transfer sheet provided with the clear coat layer.

15. The process of claim 2 wherein the transfer sheet is folded around a three-dimensional structure.

16. The process of claim 3 wherein the transfer sheet is folded around a three-dimensional structure.

17. The process of claim 2 wherein the substrate to be coated has a coating layer with a thickness of 1-200 microns.

18. The process of claim 3 wherein the substrate to be coated has a coating layer with a thickness of 1-200 microns.

19. The process of claim 9 wherein the coating layer is a powder coating layer.

20. The process of claim 18 wherein the coating layer is a powder coating layer.
